(19) United States
(12) Patent Application Publication
(10) Pub. No.: US 2009/0279164 A1
(43) Pub. Date: Nov. 12, 2009

(54) Bi-directional propagation optical signal regenerator and optical signal regenerating method utilizing optical nonlinear effect

(75) Inventor: Masayuki Matsumoto, Osaka (JP)

Correspondence Address: HAMRE, SCHUMANN, MUELLER & LARSON, P.C., P.O. BOX 2902, MINNEAPOLIS, MN, 55402-0902, US

(73) Assignee: Osaka University, Suita-shi, Osaka (JP)

(21) Appl. No.: 12/308,781

(22) PCT Filed: Jun. 26, 2007
(86) PCT No.: PCT/JP2007/062739

§ 371 Date: Dec. 23, 2008

(30) Foreign Application Priority Data
Jun. 30, 2006 (JP) 2006-182224

(51) Int. Cl. H01S 3/00

(52) U.S. Cl. 359/334

(57) ABSTRACT

An optical nonlinear medium 1, first and second optical circulators 2, 3 that are connected respectively to a front end and a rear end of the optical nonlinear medium, a first optical amplifier 4 that amplifies an inputted optical signal and causes it to enter the first optical circulator 2, a first optical filter 5 that passes light in a predetermined wavelength range, into which outgoing light passing through the first optical circulator, entering the front end of the optical nonlinear medium and leaving the rear end thereof enters through the second optical circulator, a second optical amplifier 6 that amplifies an optical signal passing through the first optical filter and causes it to enter the second optical circulator 3, and a second optical filter 7 that passes light in a predetermined wavelength range, into which returning light passing through the second optical circulator, entering the rear end of the optical nonlinear medium and leaving the front end thereof enters through the first optical circulator are provided. It is possible to reduce the length of the optical nonlinear medium that is needed for regenerating an optical signal utilizing a nonlinear optical effect.

### TECHNICAL FIELD

The present invention relates to an optical signal regenerator and an optical signal regenerating method utilizing an optical nonlinear effect for removing in an optical region a signal waveform distortion and an amplifier noise that are generated and accumulated during optical signal transmission in an optical fiber communication network or the like.

### BACKGROUND ART

In a current optical fiber communication network, processes such as signal path switching, signal multiplexing and demultiplexing, and signal regeneration in the network are carried out in an electric region through optical/electrical conversion and electrical/optical conversion. Currently, the speed at which the signal can be processed in the electric region is at most several tens of Gbps, and phase information of the optical signal is lost with the optical/electrical conversion. Accordingly, because of this electric signal processing in the network, the potential for very high speed, transparency and flexibility of the optical fiber communication network cannot be utilized fully.

As a method for solving this problem, attention has been paid to replacing the electric signal processing by an all-optical signal processing, and active studies thereon have been conducted. One of the all-optical signal processings that is important in long distance transmission is an optical signal regeneration. The optical signal regeneration is a method of removing in an optical region the accumulation of signal waveform distortion and amplifier noise resulting from various dispersibility and nonlinearity of transmission fibers and network elements, and is a signal processing that is indispensable for realizing a large-scale all-optical network. Optical signal regenerators are classified into a 2R type regenerator having a reamplification function and a waveform reshaping function, and a 3R type regenerator having a retiming function in addition to the above-noted functions.

In any of the regenerators, it is essential to utilize a nonlinear optical effect in order to achieve the waveform reshaping function including a threshold processing in the optical region. Also, the retiming in most of the 3R type regenerators is achieved as follows: a clock pulse train that is generated in synchronization with an input signal and is jitter-free is turned ON/OFF with an input signal pulse. The utilization of the optical nonlinearity is necessary for achieving this switching operation. Representative materials showing the nonlinearity in the optical region include an optical fiber and a semiconductor device such as a semiconductor optical amplifier.

Among them, the optical fiber has a nonlinear response time on the order of femtoseconds and thus is applicable to a signal processing at a speed exceeding several hundred Gbps, though it only has a low degree of integration. Further, not only a highly nonlinear silica fiber (with a nonlinear phase shift coefficient γ of about 20/W/km) that has a core doped with a high concentration of GeO₂ and has a small effective core cross-section but also a highly nonlinear optical fiber (with γ of at least several hundred/W/km) that is a combination of a glass material having a large nonlinearity and a holey fiber structure has been developed recently. As described above, there is an active effort underway to reduce a necessary fiber length.

Various kinds of the optical signal regenerator utilizing the nonlinear optical effect of the optical fiber have been proposed. Among them, an optical signal regenerator utilizing a self-phase modulation effect will be described in the following.

A medium forming a fiber (principally, silica glass) has a nonlinearity called the Kerr effect, and its refractive index varies according to the light intensity in the medium. The refractive index variation of the medium causes a phase change of signal light that propagates in the fiber. The amount ∠φ of the phase change due to an electric power of the signal light itself (a self-phase modulation: SPM) is given by ∠φ=γPL, where γ indicates the nonlinear coefficient, P indicates the electric power of the signal light and L indicates the fiber length. In the case of a highly nonlinear optical fiber with a nonlinear coefficient of γ=20/W/km, when the fiber length is selected to be L=1 km, for example, a phase change of about π is caused with respect to the light electric power of about 160 mW, so that an electric power controlled switching operation or the like is achieved. Since the signal regenerator utilizing SPM utilizes the nonlinear effect dependent on the input signal intensity and uses part of the input signal as an output signal, a probe light source or a pump light source does not have to be provided in the regenerator, leading to a simplified device configuration.

As the signal regenerator utilizing SPM, Patent document 1 discloses the one combining a nonlinear spectral band width fluctuation in the fiber and an optical bandpass filtering. FIG. 6 is a schematic view of the configuration thereof. A signal regenerator shown in FIG. 6 includes a highly nonlinear fiber (HNLF) 1a, an optical amplifier 4 and a narrow-band optical bandpass filter (OBPF) 5a. The SPM effect in the highly nonlinear fiber 1a broadens a spectrum depending on the signal electric power, so that an output is taken out via the OBPF 5a whose center wavelength and band width are fixed, thereby making it possible to provide a nonlinear relationship between an input signal electric power and an output signal electric power.

Since this configuration does not utilize an optical interference effect, it has an advantage in that a stable operation with a small input polarization dependence is possible and an allowable range of setting a parameter of constituent elements is relatively wide. The signal regenerator shown in FIG. 6 can be classified by its operation principle into two kinds, namely, a spectral band width broadening/spectrum slicing type (in the following, referred to as a spectrum slicing type) regenerator using a normal dispersion highly nonlinear optical fiber and a soliton compressing/filtering type (in the following, referred to as a soliton type) regenerator using an anomalous dispersion highly nonlinear optical fiber.

In the spectrum slicing type regenerator, as shown in FIG. 6, an input signal pulse S₀ (with a wavelength λs) is amplified by the optical amplifier 4 (to be a signal S₁) and then inputted in the normal dispersion highly nonlinear fiber 1a, where its spectral band width is broadened (to be a signal S₂). The fluctuation of an input pulse amplitude mainly appears as the fluctuation of a spectral band width in the output, and the electric power density of the spectrum does not vary very much. Accordingly, by slicing a part of the broadened spectrum with the OBPF 5a, it is possible to take out an output pulse S₃ with a stabilized energy. Also, when the input signal (pulse) S₀ has a small amplitude, the spectrum is not broadened. Therefore, by shifting a center wavelength in a pass band characteristic F1 of the OBPF from an input signal wavelength (to λ+Δλ), an input signal with a low electric power is not outputted but removed by the regenerator. Thus, this signal regenerator stabilizes the amplitude of the signal pulse as well as has a function of removing noise in a no signal state.

In the case of the soliton type regenerator, when a peak electric power of an input pulse is larger than a basic soliton peak electric power P_{P} in the highly nonlinear optical fiber, a pulse compression occurs, and a spectral band width in the fiber output is broadened. When the peak electric power of the input pulse is smaller than P_{P}, a pulse width of solitons appearing in the fiber output is broadened, so that a spectral band width of a signal other than a dispersive wave becomes narrow. Therefore, the OBPF placed at the fiber output inflicts a loss depending on the fiber input pulse electric power (the loss is larger when the input electric power is larger) on the pulse, thus stabilizing the amplitude of the pulse. This regenerator is different from the spectrum slicing type regenerator in that the center wavelength of the OBPF is equal to the wavelength of the input signal. This signal regenerator has a problem in that, only by combining the nonlinear fiber and the OBPF, the noise in the no signal state (noise in the OBPF band) is not removed, but rather gradually amplified. In the case of inserting a large number of the regenerators in a transmission line so as to regenerate signals repeatedly, it also is necessary to stabilize the no signal state. To this end, an additional element having a saturable absorbing characteristic has to be inserted in the regenerator.

A synchronous amplitude modulator has a function of retiming a pulse train and can achieve the 3R operation with a simple configuration. Also, since the synchronous amplitude modulation inflicts a loss on a linear wave with a low amplitude such as noise, the no signal state can be stabilized in the soliton type regenerator without using a saturable absorbing element.

The spectrum slicing type regenerator has more digital input/output characteristics and produces a greater amplitude regenerating effect. In the soliton type regenerator, the input/output characteristics have a small nonlinearity, so that the amplitude regenerating effect in each operation of the regenerator is small. However, by arranging a large number of the regenerators in the transmission line, it is possible to achieve high-quality stable signal transmission. Further, the energy of a signal to be inputted to the HNLF only needs to be a fraction of the energy in the case of the spectrum slicing type regenerator.

The effectiveness of these signal regenerators has been confirmed by a long distance transmission experiment. For the spectrum slicing type regenerator, a 40 Gbps 1,000,000 km circulating loop transmission experiment (a signal Q value is at least 19 dB and an interval between the regenerators is 400 km) in combination with the retiming by the synchronous amplitude modulation has been reported.

Patent document 1: JP 2002-77052 A

### DISCLOSURE OF INVENTION

### Problem to be Solved by the Invention

In the above-described conventional optical signal regenerators utilizing the nonlinear effect of the optical fiber, the optical signal is regenerated by causing an amplified optical signal to enter the highly nonlinear optical fiber with a length of several hundred meters so as to broaden its spectral band width. In order to broaden the spectral band width sufficiently in this manner, the highly nonlinear optical fiber has to be long enough.

Further, with an increase in the scale and speed of the optical transmission network, a larger number of the optical signal regenerators become necessary. Therefore, a larger amount of expensive highly nonlinear optical fibers is used, resulting in a soaring cost of an optical signal transmission system.

Accordingly, it is an object of the present invention to provide an optical signal regenerator capable of reducing the length of an optical nonlinear medium such as an optical fiber that is needed for regenerating an optical signal utilizing a nonlinear optical effect.

### Means for Solving Problem

In order to solve the problem described above, a bi-directional propagation optical signal regenerator according to the present invention includes an optical nonlinear medium that has a nonlinear optical effect on propagating light, a first optical circulator and a second optical circulator that are connected respectively to a front end and a rear end of the optical nonlinear medium, a first optical amplifier that amplifies an inputted optical signal and causes it to enter the first optical circulator, a first optical filter that passes light in a predetermined wavelength range, into which outgoing light passing through the first optical circulator, entering the front end of the optical nonlinear medium and leaving the rear end thereof enters through the second optical circulator, a second optical amplifier that amplifies an optical signal passing through the first optical filter and causes it to enter the second optical circulator, and a second optical filter that passes light in a predetermined wavelength range, into which returning light passing through the second optical circulator, entering the rear end of the optical nonlinear medium and leaving the front end thereof enters through the first optical circulator. The optical signal inputted to the first optical amplifier passes through the optical nonlinear medium, the first optical filter, the second optical amplifier, the optical nonlinear medium and the second optical filter in this order and is outputted.

A bi-directional propagation optical signal regenerating method according to the present invention includes amplifying an inputted optical signal by a first optical amplifier and then causing it to enter a front end of an optical nonlinear medium and propagate therein, thereby providing a nonlinear optical effect, filtering the optical signal that has left a rear end of the optical nonlinear medium by a first optical filter that passes light in a predetermined wavelength range, amplifying the optical signal that has passed through the first optical filter by a second optical amplifier and then causing it to enter the rear end of the optical nonlinear medium and propagate therein, thereby providing a nonlinear optical effect, and filtering the optical signal that has left the front end of the optical nonlinear medium by a second optical filter that passes light in a predetermined wavelength range, and outputting the resultant optical signal.

### Effects of the Invention

In accordance with the present invention, by amplifying an optical signal outputted from an optical nonlinear medium and then causing it to enter the same optical nonlinear medium again and propagate therein in an opposite direction, it is possible to achieve a doubly-amplified regeneration effect using the single optical nonlinear medium two times. Thus, an expensive optical nonlinear medium is utilized effectively, thereby allowing a reduction of the use amount of the optical nonlinear medium.

The present invention is based on the result of the inventor's experiment confirming that, even if optical signals propagating bi-directionally in an optical nonlinear medium have a large signal intensity, they do not interact substantially and thus independent wave propagation is achieved.

### BRIEF DESCRIPTION OF DRAWINGS

FIG. 1 shows a schematic configuration of a bi directional propagation optical signal regenerator in Embodiment 1 of the present invention.

FIG. 2A is a drawing for describing an effect of the optical signal regenerator shown in FIG. 1.

FIG. 2B is a drawing for describing an effect of the optical signal regenerator shown in FIG. 1.

FIG. 2C is a drawing for describing an effect of the optical signal regenerator shown in FIG. 1.

FIG. 3 shows spectra of an optical signal in individual parts obtained in an experiment of a performance of the optical signal regenerator shown in FIG. 1.

FIG. 4 shows an optical signal transmission system in Embodiment 2 of the present invention.

FIG. 5 is a block diagram showing an optical receiver including a noise removing device in Embodiment 3 of the present invention.

FIG. 6 shows a schematic configuration of an optical signal regenerator in a conventional example.

### EXPLANATION OF LETTERS OR NUMERALS

1 Optical nonlinear medium

1a Highly nonlinear fiber

2 First optical circulator

3 Second optical circulator

4 First optical amplifier

5 First optical filter

5a Optical filter

6 Second optical amplifier

7 Second optical filter

8 Bi-directional propagation optical signal regenerator

10 Optical transmitter

11a to 11d Optical fiber transmission lines

12, 13 Optical amplifiers

14, 15 Optical receivers

16 Optical decoder

17 Interference noise removing device

18 Code judging unit

### DESCRIPTION OF THE INVENTION

The present invention can be in the following various modes based on the above-described configuration.

That is, in the bi-directional propagation optical signal regenerator with the above-described configuration, the optical nonlinear medium can provide the nonlinear optical effect so as to generate a chirp in the inputted optical signal, and the first optical filter and the second optical filter can have a pass band characteristic of removing a component with a small chirp from the optical signal outputted from the optical nonlinear medium.

Also, the optical nonlinear medium can be a normal dispersion highly nonlinear optical fiber so as to broaden a spectral band width of the optical signal while the optical signal is propagating in the optical nonlinear medium, a center wavelength in a pass band characteristic of the first optical filter can be shifted from an input signal wavelength λ by Δλ, and a center wavelength in a pass band characteristic of the second optical filter can be equal to the input signal wavelength λ.

Further, it is preferable that the first optical amplifier and the second optical amplifier amplify the optical signal to a range in which a predetermined nonlinear optical effect is obtained by the optical nonlinear medium.

An optical signal transmission system according to the present invention includes an optical fiber transmission line that transmits an optical signal, and the bi-directional propagation optical signal regenerator with any of the above-described configurations that is disposed in the optical fiber transmission line. The optical signal from a transmitting side of the optical fiber transmission line is inputted to the first optical amplifier, and an output from the second optical filter is supplied to a receiving side of the optical fiber transmission line.

An optical receiver according to the present invention is constituted so as to have an optical signal processing portion that subjects an input optical signal to a predetermined processing and demodulate a transmission signal from the input optical signal. The optical signal processing portion includes the bi-directional propagation optical signal regenerator with any of the above-described configurations, a signal inputted to the optical signal regenerator is inputted to the first optical amplifier, and an output from the second optical filter serves as an output signal of the optical signal regenerator.

The following is a description of embodiments of the present invention, with reference to the accompanying drawings.

### EMBODIMENT 1

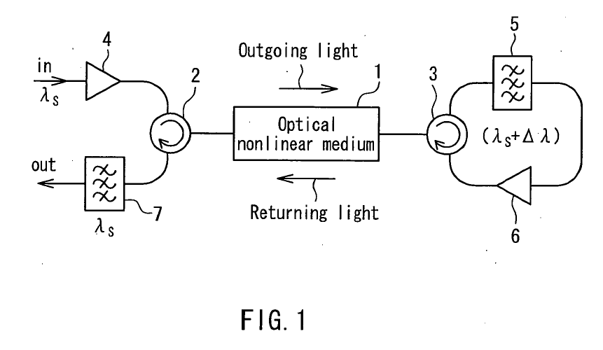

FIG. 1 shows a schematic configuration of a bi-directional propagation optical signal regenerator in Embodiment 1 of the present invention.

An optical nonlinear medium 1 is formed of, for example, a highly nonlinear silica fiber, which has a nonlinear optical effect on propagating light. In the present embodiment, the optical nonlinear medium 1 provides normal dispersion as the nonlinear optical effect. Thus, while an optical signal is propagating in the optical nonlinear medium 1, its spectral band width is broadened. A first optical circulator 2 and a second optical circulator 3 are connected respectively to a front end and a rear end of the optical nonlinear medium 1.

An input optical signal to the optical signal regenerator is inputted to and amplified in a first optical amplifier 4. Output light from the first optical amplifier 4 passes through the first optical circulator 2, enters the optical nonlinear medium 1 and propagates therein as outgoing light. After this outgoing light leaves the rear end of the optical nonlinear medium 1, it passes through the second optical circulator 3 and enters a first optical filter 5. The first optical filter 5 passes only light in a predetermined wavelength range described later among the outgoing light whose spectral band width has been broadened by the optical nonlinear medium 1.

The optical signal that has passed through the first optical filter 5 is amplified by a second optical amplifier 6. The light outputted from the second optical amplifier 6 passes through the second optical circulator 3, enters the optical nonlinear medium 1 again and propagates therein as returning light. After this returning light leaves the front end of the optical nonlinear medium 1, it passes through the first optical circulator 2 and enters a second optical filter 7. The second optical filter 7 passes only light in a predetermined wavelength range described later among the returning light whose spectral band width has been broadened by the optical nonlinear medium 1.

As described above, the optical signal inputted to the first optical amplifier 4 passes through the first optical circulator 2, the optical nonlinear medium 1, the first optical filter 5, the second optical amplifier 6, the second optical circulator 3, the optical nonlinear medium 1, the first optical circulator 2 and the second optical filter 7 in this order and is outputted from the optical signal regenerator.

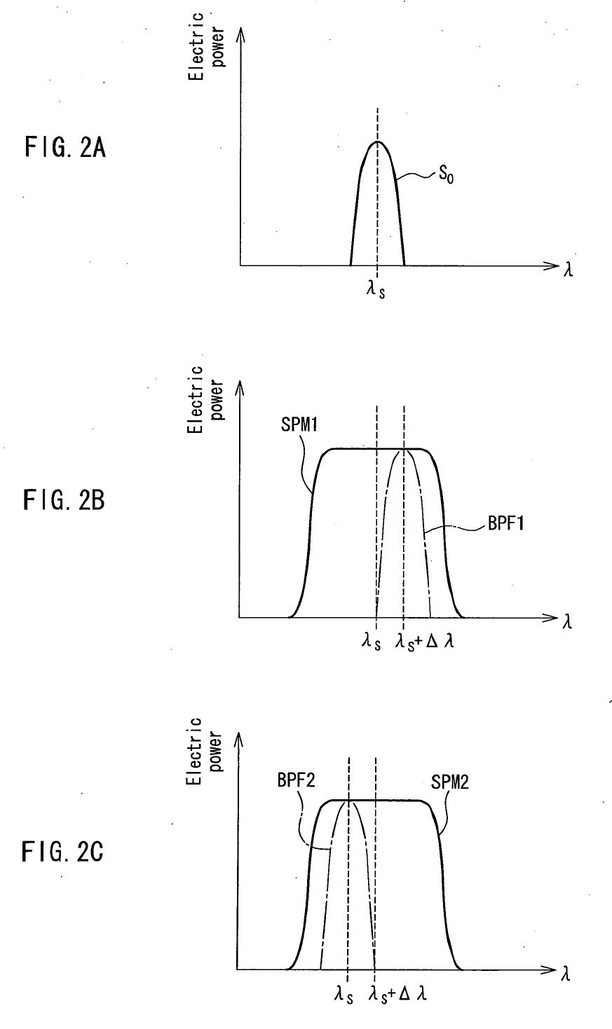

The effect obtained by the above-described configuration will be described with reference to FIG. 2. In each figure of FIG. 2, the horizontal axis indicates a wavelength, and the vertical axis indicates an optical signal intensity.

FIG. 2A shows an input signal S₀ having a wavelength λs. FIG. 2B shows a signal SPM1 that is amplified by the first optical amplifier 4 and whose spectral band width is broadened by the optical nonlinear medium 1, and a pass band characteristic BPF1 of the first optical filter 5. The signal SPM1 has a center wavelength of λs, and the pass band characteristic BPF1 has a center wavelength of (λs+Δλ). By slicing the spectrum in the wavelength range shifted from the wavelength λs of the input signal S₀ in this manner, an input signal with a low electric power is removed.

FIG. 2C shows a signal SPM2 that is amplified by the second optical amplifier 6 and whose spectral band width is broadened by the optical nonlinear medium 1, and a pass band characteristic BPF2 of the second optical filter 7. The signal SPM2 has a center wavelength of (λs+Δλ), and the pass band characteristic BPF2 has a center wavelength of λs. By setting the center wavelengths in this way, it is possible to put the wavelength of the output signal of the optical signal regenerator back to the wavelength λs of the input signal S₀ while producing the effect similar to the first optical filter 5.

However, for achieving the effect of the present invention, it is not essential to set the pass band characteristic of the optical filter as described above. Even when the wavelength of the output signal of the optical signal regenerator is different from the wavelength λs of the input signal S₀, it also is possible to restore the wavelength of the optical signal with an optical signal regenerator arranged at a later stage, for example.

As described above, the optical nonlinear medium 1 is set to provide the nonlinear optical effect so as to generate a chirp in the inputted optical signal, and the first optical filter 5 and the second optical filter 7 are set to have the pass band characteristic of removing a component with a small chirp from the optical signal outputted from the optical nonlinear medium 1. This produces the effect that the input signal with a low electric power is not outputted but removed by the optical signal regenerator, the amplitude of the signal pulse is stabilized and the noise in the no signal state is removed.

In order to achieve such an effect sufficiently, the first optical amplifier 4 and the second optical amplifier 6 are set so as to amplify the optical signal to a range in which a predetermined nonlinear optical effect is obtained by the optical nonlinear medium 1. The optical amplifiers can be, for example, an erbium doped fiber amplifier (EDFA).

The following experiment was conducted to confirm that, even if the optical signals propagating bi-directionally in the optical nonlinear medium as in the above-described configuration had a large signal intensity, they did not interact substantially and thus independent wave propagations were achieved. In other words, the optical signal regenerator with the configuration described above was examined for a performance of regenerating an optical signal of 10 Gb/s. A semiconductor laser that was mode-locked by a short pulse and oscillating at 1548.5 nm was used as a 10 GHz pulse train source. After the amplitude of the pulse was modulated by a LiNbO₃ optical modulator, the pulse was passed through the OBPF with a band width of 1 nm, thus broadening the pulse time width to 4.3 ps. The damping ratio of the pulse train was controlled by a drive voltage of the modulator. The resultant optical signal of 10 Gb/s was inputted to the optical signal regenerator.

In the optical signal regenerator, the optical signal was amplified by the EDFA and then inputted to the HNLF. The HNLF had a dispersion of −0.35 ps/nm/km (at a wavelength of 1548.5 nm), a dispersion slope of 0.03 ps/nm²/km, a nonlinear coefficient of 16.2/W/km, a loss of 0.52 dB/km and a length of 1,800 m. With respect to the optical signal whose spectrum had been broadened by the HNLF, spectrum slicing was carried out by the first OBPF. The first OBPF had a center wavelength of 1550 to 1551 nm. The output signal from the first OBPF was amplified again, inputted to the same HNLF and subjected to spectrum slicing by the second OBPF. The second OBPF had a center wavelength equal to the wavelength of the input signal.

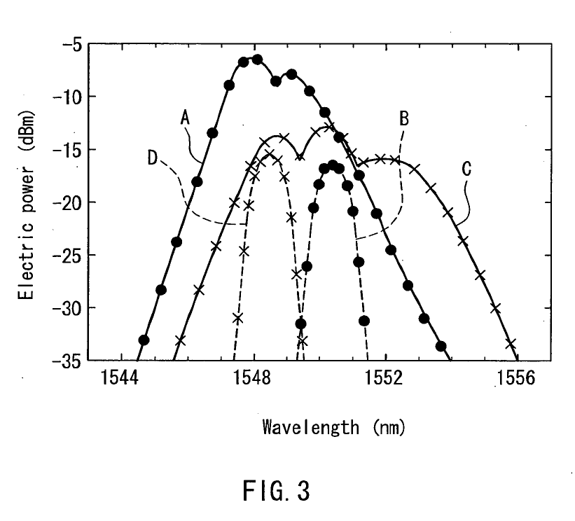

In FIG. 3, a curve A indicates the spectrum of the outgoing light outputted from the HNLF, a curve B indicates the output of spectrum slicing by the first OBPF, a curve C indicates the spectrum of the returning light outputted from the HNLF, and a curve D indicates the output of spectrum slicing by the second OBPF. The outgoing light and the returning light that were outputted from the HNLF had a signal electric power of 9.7 dBm and 12.9 dBm, respectively. When a spectrum was broadened sufficiently, it was shown that the optical signals propagating bi-directionally did not interact substantially.

The following is an example of the highly nonlinear optical fiber (HNLF) used as the optical nonlinear medium for constituting the bi-directional propagation optical signal regenerator according to the present embodiment. The HNLF has a length of 1.5 km, a loss of 0.5 dB/km and a nonlinear coefficient of 20/W/km. In the case of the spectrum slicing type regenerator, the HNLF has a dispersion of −0.5 ps/nm/km, and the OBPF has a band width of 150 GHz and a shift of the center wavelength of 2.5 nm. In the case of the soliton type regenerator, the HNLF has a dispersion of 1 ps/nm/km, and the OBPF has a band width of 300 GHz.

### EMBODIMENT 2

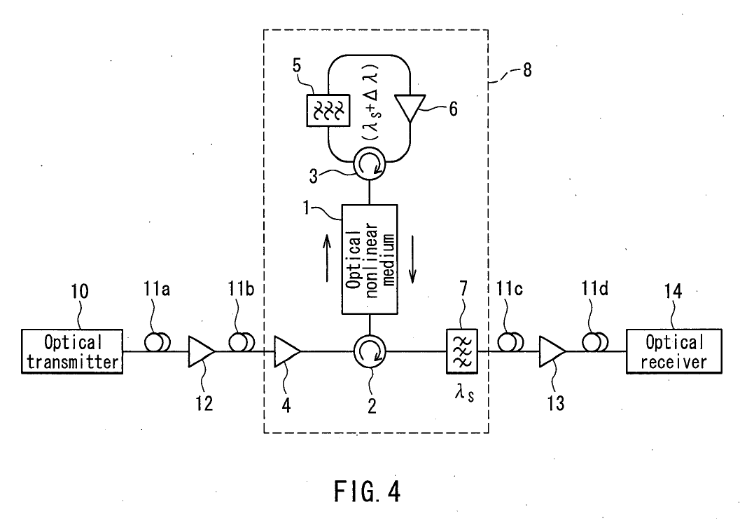

FIG. 4 illustrates an optical signal transmission system, which is an example in which a bi-directional propagation optical signal regenerator 8 with the above-described configuration is incorporated. This system is constituted by inserting the bi-directional propagation optical signal regenerator 8, optical amplifiers 12 and 13, etc. in optical fiber transmission lines 11a to 11d transmitting an optical signal. An optical transmitter 10 is connected to a transmitting side of the system, and an optical receiver 14 is connected to a receiving side thereof.

In accordance with the optical signal transmission system with the configuration described above, it is possible to make an efficient use of the optical nonlinear medium 1, thus achieving a cost reduction of the optical signal regenerator 8.

### EMBODIMENT 3

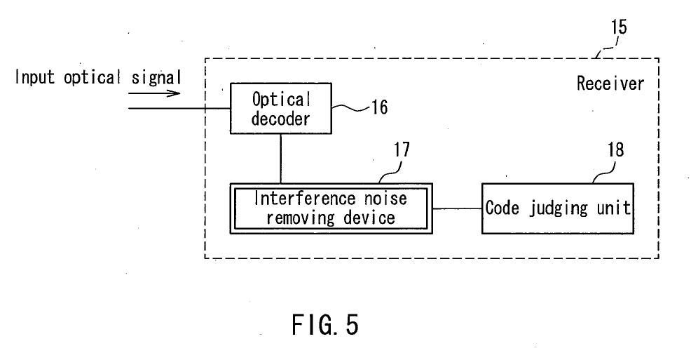

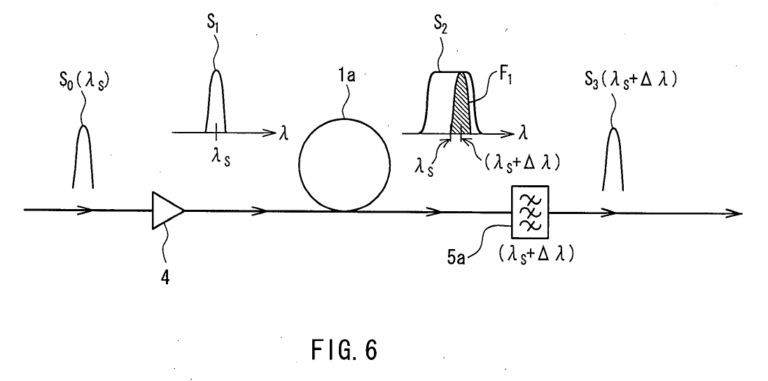

FIG. 5 illustrates an optical receiver 15, which is another example in which the bidirectional propagation optical signal regenerator 8 with the configuration of Embodiment 1 is incorporated. This optical receiver 15 is used in an optical code division multiple access communication system, for example. An optical signal inputted via the system is decoded by an optical decoder 16 and then inputted to an interference noise removing device 17. An output signal from the interference noise removing device 17 is inputted to a code judging unit 18, in which its code is judged.

The interference noise removing device 17 is constituted by the bidirectional propagation optical signal regenerator 8 according to Embodiment 1 and regenerates the optical signal from the optical decoder 16 as described above. At this time, since the noise in the no signal state is removed as described above, it is possible to achieve an effect of removing an interference noise.

The bi-directional propagation optical signal regenerator according to the present invention is applicable not only to the above-described embodiments but also for the noise removal and the optical amplitude stabilization in general optical signal processing.

### INDUSTRIAL APPLICABILITY

The bi-directional propagation optical signal regenerator according to the present invention can achieve the simplification and size reduction of a transmission system by making an efficient use of an expensive optical nonlinear medium, and is useful for constructing an optical fiber communication network or the like.

1. A bidirectional propagation optical signal regenerator comprising:
an optical nonlinear medium that has a nonlinear optical effect on propagating light;
a first optical circulator and a second optical circulator that are connected respectively to a front end and a rear end of the optical nonlinear medium;
a first optical amplifier that amplifies an inputted optical signal and causes it to enter the first optical circulator;
a first optical filter that passes light in a predetermined wavelength range, into which outgoing light passing through the first optical circulator, entering the front end of the optical nonlinear medium and leaving the rear end thereof enters through the second optical circulator;
a second optical amplifier that amplifies an optical signal passing through the first optical filter and causes it to enter the second optical circulator; and
a second optical filter that passes light in a predetermined wavelength range, into which returning light passing through the second optical circulator, entering the rear end of the optical nonlinear medium and leaving the front end thereof enters through the first optical circulator;
wherein the optical signal inputted to the first optical amplifier passes through the optical nonlinear medium, the first optical filter, the second optical amplifier, the optical nonlinear medium and the second optical filter in this order and is outputted.

2. The bidirectional propagation optical signal regenerator according to claim 1, wherein the optical nonlinear medium provides the nonlinear optical effect so as to generate a chirp in the inputted optical signal, and the first optical filter and the second optical filter have a pass band characteristic of removing a component with a small chirp from the optical signal outputted from the optical nonlinear medium.

3. The bidirectional propagation optical signal regenerator according to claim 1, wherein the optical nonlinear medium is a normal dispersion highly nonlinear optical fiber so as to broaden a spectral band width of the optical signal while the optical signal is propagating in the optical nonlinear medium,
a center wavelength in a pass band characteristic of the first optical filter is shifted from an input signal wavelength λ by Δλ, and a center wavelength in a pass band characteristic of the second optical filter is equal to the input signal wavelength λ.

4. The bidirectional propagation optical signal regenerator according to claim 1, wherein the first optical amplifier and the second optical amplifier amplify the optical signal to a range in which a predetermined nonlinear optical effect is obtained by the optical nonlinear medium.

5. An optical signal transmission system comprising:
an optical fiber transmission line that transmits an optical signal; and
the bidirectional propagation optical signal regenerator according to claim 1 that is disposed in the optical fiber transmission line;
wherein the optical signal from a transmitting side of the optical fiber transmission line is inputted to the first optical amplifier, and an output from the second optical filter is supplied to a receiving side of the optical fiber transmission line.

6. An optical receiver comprising an optical signal processing portion that subjects an input optical signal to a predetermined processing and demodulating a transmission signal from the input optical signal;
wherein the optical signal processing portion comprises the bidirectional propagation optical signal regenerator according to claim 1, a signal inputted to the optical signal regenerator is inputted to the first optical amplifier, and an output from the second optical filter serves as an output signal of the optical signal regenerator.

7. A bidirectional propagation optical signal regenerating method comprising:
amplifying an inputted optical signal by a first optical amplifier and then causing it to enter a front end of an optical nonlinear medium and propagate therein, thereby providing a nonlinear optical effect;
filtering the optical signal that has left a rear end of the optical nonlinear medium by a first optical filter that passes light in a predetermined wavelength range;
amplifying the optical signal that has passed through the first optical filter by a second optical amplifier and then causing it to enter the rear end of the optical nonlinear medium and propagate therein, thereby providing a nonlinear optical effect; and
filtering the optical signal that has left the front end of the optical nonlinear medium by a second optical filter that passes light in a predetermined wavelength range, and outputting the resultant optical signal.
